(19) United States
(12) Patent Application Publication
(10) Pub. No.: US 2005/0282841 A1
(43) Pub. Date: Dec. 22, 2005

(54) Novel esters as useful broad spectrum fungicidal compounds

(76) Inventor: Joel Marcel Coret, Princeton, NJ (US)

Correspondence Address: John Shedden, 272 Harbor Ridge Drive, Statesville, NC, 28677, US

(21) Appl. No.: 11/156,854

(22) Filed: Jun. 20, 2005

Related U.S. Application Data
(60) Provisional application No. 60/581,659, filed on Jun. 21, 2004.
(60) Provisional application No. 60/581,660, filed on Jun. 21, 2004.
(60) Provisional application No. 60/581,682, filed on Jun. 21, 2004.
(60) Provisional application No. 60/581,682, filed on Jun. 21, 2004.

(51) Int. Cl. A01N 43/54

(52) U.S. Cl. 514/269; 544/316

(57) ABSTRACT

The instant invention relates to the discovery of certain novel fungicidal esters of agriculturally active acids. These esters can present agronomical advantages over traditional fungicidal products by presenting multiple fungicidal mechanisms that ensure activity over a broad fungi spectrum while limiting the appearance of fungi resistance.

The present application claims the benefits accorded under 35 U.S.C. 119(e) of prior provisional application Nos. 60/581,659, 60/581,660, and 60/581,682; all filed on 21 Jun. 2004.

### FIELD OF THE INVENTION

The instant invention relates to novel fungicidal ester compounds and the discovery that compositions containing these compounds can present many agronomical advantages over the use of traditional products.

### BACKGROUND OF THE INVENTION

Pesticides are widely regarded as an efficient way of optimizing agricultural production by reducing the pressure from pests and other organisms on the growing crops. Both the quantity and the quality of crops are increased by use of chemical compounds that reduces damage to the crop by insects, fungi or weeds.

In order to reduce the damage caused to the plant, seeds or fruit by fungal attack, organic and inorganic fungicides have proven effective in eradicating or limiting growth of fungal organisms on crops, fruit trees and on vines, as well as on fruit or seeds that may be present. Among the fungicides already described, there are several molecules that present carboxylic acid groups. These are often derivatized into methyl, ethyl, isopropyl or butyl esters by reaction with the corresponding alcohol. Several compounds with hydroxyl groups presenting fungicidal activity are also known. Although the efficiency of these compounds against a particular species or genera of fungi is usually acceptable, their spectrum of activity against the large variety of fungal species is usually too narrow to provide sufficient protection to the treated locus against attack from all common species of fungi. In order to provide adequate protection, or to eradicate a larger portion of the fungi that are present, the farmer is usually constrained to apply more than one fungicidal compound over his crops. The accompanying cost of treatment and of labor when products are applied consecutively is a drawback of existing fungicidal compounds. The present invention provides for compounds that present broader spectrum of activity against fungal species than existing compounds and address the problems described above. It has been found that novel esters formed from multiple, different fungicidal components (acid(s) and/or alcohol(s)), provide compounds that offer activity against more than one cellular target and provide superior fungicidal activity than either of the precursor products. This presents a number of advantages: need for reduced number of compounds to be applied and preventing the appearance of resistant fungal strains to a given precursor compound.

### SUMMARY OF THE INVENTION

The present invention relates to the discovery of certain novel fungicidal ester compounds that are generally composed of one or more fungicidal acid groups esterified onto a range of hydrophilic diols or polyols. Agricultural compositions containing these compounds realize enhanced broad spectrum fungicidal activity.

### DETAILED DESCRIPTION OF THE INVENTION

The present invention thus relates to novel fungicidal ester compounds. These compounds are composed of one ore more fungicidal acid groups esterified onto a range of hydrophilic diols or polyols.

The novel compounds that present these characteristics and which are considered to be covered by the present invention include those of the formula:
R—CO—O—R′
wherein RCOO is an acetate of one of the following acids:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim-Me),
(RS)-3-(3,5-dichlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyracolstrobin), and
(E)-methoxyimino-{(E)-α-[1-(α,α,α-trifluoro-m-tolyl)ethylideneaminooxy]-o-tolyl}acetic acid (trifloxystrobin),
   and R′ is the corresponding alkyl group of an alcohol of at least one of the following structures:
(2RS,3RS;2RS,3SR)-2-(4-chlorophenyl)-3-cyclopropyl-1-(1H-1,2,4-triazol-1-yl)butan-2-ol (cyproconazole),
(1RS,2SR,5RS;1RS,2SR,5SR)-2-(4-chlorobenzyl)-5-isopropyl-1-(1H-1,2,4-triazol-1-ylmethyl)cyclopentanol (ipconazole),
(1RS,5RS;1RS,5SR)-5-(4-chlorobenzyl)-2,2-dimethyl-1-(1H-1,2,4-triazol-1-ylmethyl)cyclopentanol (metconazole),
(RS)-2-(4-fluorophenyl)-1-(1H-1,2,4-triazol-1-yl)-3-(trimethylsilyl)propan-2-ol (simeconazole),
(RS)-1-p-chlorophenyl-4,4-dimethyl-3-(1H-1,2,4-triazol-1-ylmethyl)pentan-3-ol (tebuconazole),
(RS-(E)-5-(4-chlorobenzylidene)-2,2-dimethyl-1-(1H-1,2,4-triazol-1-ylmethyl)cyclopentanol (triticonazole),
5-butyl-2-ethylamino-6-methylpyrimidin-4-ol (ethirimol),
5-butyl-2-dimethylamino-6-methylpyrimidinol (dimethirimol),
(RS)-2,4′-dichloro-α-(pyrimidin-5-yl)benzhydryl alcohol (fenarimol),
(RS)-2-chloro-4′-fluoro-α-(pyrimidin-5-yl)benzhydryl alcohol (nuarimol),
(RS)-2,4-dichloro-α-(pyrimidin-5-yl)benzhydryl alcohol (triarimol),
β-([1,1′-biphenyl]-4-yloxy)-α-(1,1-dimethylethyl)-1H-1,2,4-triazole-1-ethanol (bitertanol),
(RS)-2-(2,4-dichlorophenyl)-1-(1H-1,2,4-triazol-1-yl)hexan-2-ol,
(RS)-2,4-difluoro-α-(1H-1,2,4-triazol-1-ylmethyl)benzhydryl alcohol,
(E)-(RS)-1-(2,4-dichlorophenyl)-4,4-dimethyl-2-(1H-1,2,4-triazol-1-yl)pent-1-en-3-ol,
(2RS,3RS)-1-(2,4-dichlorophenyl)-4,4-dimethyl-2-(1H-1,2,4-triazol-1-yl)pentan-3-ol,
(RS)-2-[2-(1-chlorocyclopropyl)-3-(2-chlorophenyl)-2-hydroxypropyl]-2,4-dihydro-1,2,4-triazol-3-thione, and
(1RS,2RS;1RS,2SR)-1-(4-chlorophenoxy)-3,3-dimethyl-1-(1H-1,2,4-triazol-1-yl)butan-2-ol.

Alternatively, two or more types of organic acids presenting fungicidal activity can be esterified onto a diol or polyol to form a polyester that offers excellent fungicidal activity.

Furthermore, as is described, if the polyol or diol is chosen among the more hydrophilic products described, the resulting ester is readily dispersible in water and presents good wetting properties, reducing the need for complex and expensive formulation auxiliaries. It has been found (and is an object of this invention) that certain esters present agronomical advantages over the use of traditional products, especially the capacity to be easily dispersible or to spontaneously emulsify in water upon dilution. This is obtained in specific cases where the acid compound that presents desirable agricultural properties is esterified with an alcohol or polyol with sufficiently hydrophilic properties to yield an ester that is dispersible in water under low shear.

Examples of novel compounds that present these characteristics and which are considered to be covered by present invention are more generically of the formula:
(R—COO)ₙ—R′
wherein R—COO is an acetate of a fungicidally effective carboxylic acid, and preferably, the acetate of one of the following acids:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim),
(RS)-3-(3,5-dichlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyraclostrobin),
(E)-methoxyimino-{(E)-α-[1-(α,α,α-trifluoro-m-tolyl)ethylideneaminooxy]-o-tolyl}acetic acid (trifloxystrobin),
   and R′ is an alkyl group of a polyol containing two or more carbon atoms, which may be linear or branched, saturated or unsaturated, substituted or un-substituted, optionally having hetero-atoms such as N or O within the group. R′ is preferably the alkyl group of a polyol selected from the group consisting of:
   glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
   sorbitol,
   sorbitan/sorbitol poly(oxyalkylene) condensates (in molecular weight range of 40 a.u. to 20000 a.u.),
   D-mannitol,
   D-mannitol poly(oxyalkylene) condensates (in molecular weight range of 40 a.u. to 20000 a.u.),
   poly(oxyalkylene) glycols in molecular weight range of 80 a.u. to 20000 a.u.,
   mono-capped poly(oxyalkylene) glycols in molecular weight range of 80 a.u. to 20000 a.u. capped with an alkyl or aryl group,
   pentaerythritol,
   pentaerythritol poly(oxyalkylene) condensates,
   polyvinylalcohols,
   glucosides,
   polyglucosides,
   polyvinylalcohol polymers,
   glycerol,
   glycerol poly(oxyalkylene) condensates,
   polysaccharides; polysaccharide poly(oxyalkylene) condensates,
   polyglycerides,
   polyglyceride poly(oxyalkylene) condensates,
   poly(oxyalkylene)amines, and
   poly(oxyalkylene)etheramines; and
      n is 1 or greater; the maximum number being determined according to the polyol, i.e., the degree of esterification can be as high as the polyol will allow (determined by the number of reactive hydroxyl groups present), but is preferably chosen so that the resulting polyester is composed of at least 20% by weight of the alcohol group which will enhance the dispersibility of the compound in water. Preferably n is from 1 to 3; most preferably 1 to 2.

Although the compounds that are claimed in this invention present the benefits of adequate dispersibility in water with no or minimal need of emulsifiers and surface active agents, the active ingredients can be formulated into fungicidal compositions that ensure appropriate handling characteristics and dispersibility of the active in order to optimize the active's delivery to the locus of application.

A preferred formulation for dispersible or water soluble actives is the soluble concentrate (SL), in which the active may be solubilized in an aqueous solution, which may contain surfactants and antifoams, as well as some water-soluble solvents, coupling agents or anti-freeze agents, such as a glycol. The addition of theological modifiers, adjuvants or surfactants and foam reducing agents may also be beneficial to improve handling.

Another approach that is an object of the present invention is the preparation of diesters or polyesters formed from a poly-carboxylic acid and two or more fungicidal alcohol molecules.

Compounds of this type can be described as follows:
R₁—O—CO—(CH₂)ₓ—[CH(NH₂]_{y}—[CH(OH)]_{z}—[C(OH)(COOR₁)—CH₂]_{w}—COOR₁
wherein 0≦x≧12 and 0≦y≧1 and 0≦z≧4 and 0≦w≧1; and the R₁ groups each independently represent one corresponding alkyl group selected from at least one of the following alcohols:
(2RS,3RS;2RS,3SR)-2-(4-chlorophenyl)-3-cyclopropyl-1-(1H-1,2,4-triazol-1-yl)butan-2-ol (cyproconazole),
(1RS,2SR,5RS;1RS,2SR,5SR)-2-(4-chlorobenzyl)-5-isopropyl-1-(1H-1,2,4-triazol-1-ylmethyl)cyclopentanol (ipconazole),
(1RS,5RS;1RS,5SR)-5-(4-chlorobenzyl)-2,2-dimethyl-1-(1H-1,2,4-triazol-1-ylmethyl)cyclopentanol (metconazole),
(RS)-2-(4-fluorophenyl)-1-(1H-1,2,4-triazol-1-yl)-3-(trimethylsilyl)propan-2-ol (simeconazole),
(RS)-1-p-chlorophenyl-4,4-dimethyl-3-(1H-1,2,4-triazol-1-ylmethyl)pentan-3-ol (tebuconazole),
(RS)-(E)-5-(4-chlorobenzylidene)-2,2-dimethyl-1-(1H-1,2,4-triazol-1-ylmethyl)cyclopentanol (triticonazole),
5-butyl-2-ethylamino-6-methylpyrimidin-4-ol (ethirimol),
5-butyl-2-dimethylamino-6-methylpyrimidin-4-ol (dimethirimol),
(RS)-2,4′-dichloro-α-(pyrimidin-5-yl)benzhydryl alcohol (fenarimol),
(RS)-2-chloro-4′-fluoro-α-(pyrimidin-5-yl)benzhydryl alcohol (nuarimol),
(RS)-2,4-dichloro-α-(pyrimidin-5-yl)benzhydryl alcohol (triarimol),
β-([1,1′-biphenyl]-4-yloxy)-α-(1,1-dimethylethyl)-1H-1,2,4-triazole-1-ethanol (bitertanol),
(RS)-2-(2,4-dichlorophenyl)-1-(1H-1,2,4-triazol-1-yl)hexan-2-ol,
(RS)-2,4-difluoro-α-(1H-1,2,4-triazol-1-ylmethyl)benzhydryl alcohol,
(E)-(RS)-1-(2,4-dichlorophenyl)-4,4-dimethyl-2-(1H-1,2,4-triazol-1-yl)pent-1-en-3-ol,
(2RS,3RS)-1-(2,4-dichlorophenyl)-4,4-dimethyl-2-(1H-1,2,4-triazol-1-yl)pentan-3-ol,
(RS)-2-[2-(1-chlorocyclopropyl)-3-(2-chlorophenyl)-2-hydroxypropyl]-2,4-dihydro-1,2,4-triazol-3-thione, and
(1RS,2RS;1RS,2SR)-1-(4-chlorophenoxy)-3,3-dimethyl-1-(1H-1,2,4-triazol-1-yl)butan-2-ol,

As an example, a non-restrictive list of polycarboxylic acids that would be suitable for this approach includes: citric acid, maleic acid, succinic acid and glutaric acid.

These esters can be prepared by an esterification reaction which can be carried out according to classical methods. Acids, acid halides or light alkyl esters thereof (methyl esters, for example) are progressively added to the alcohol in the presence of an appropriate catalyst (usually an acid such as toluene sulfonic acid) in a high temperature reactor under agitation. The reaction can be improved by a continuous extraction of by-products (water or light alcohol if a light ester is used as reactant) as is commonly practiced by those familiar to the art of organic synthesis. If necessary, the use of a polar, non-protic solvent or plasticizer will be beneficial in solubilizing the reactants or in reducing the viscosity of the reactive solution.

The invention therefore provides fungicidal compositions as well as a method of combating fungi, which comprises applying to a plant, to a seed of a plant, or to the locus of the plant or seed, a fungicidally effective amount of a compound as hereinbefore defined, or a composition containing the same.

The compounds may also be useful as industrial (as opposed to agricultural) fungicides, e.g. in the prevention of fungal attack on wood, hides, leather and especially paint films.

The compounds described herein can be mixed with soil, peat or other rooting media for the protection of plants against seed-borne, soil-borne or foliar fungal diseases.

The fungicidal compositions according to the invention can be formulated in various ways, depending on the prevailing biological and/or chemical-physical parameters. The following are examples of suitable formulation possibilities: wettable powders (WP), water-soluble powders (SP), water-soluble concentrates, emulsifiable concentrates (EC), emulsions (EW) such as oil-in-water and water-in-oil emulsions, sprayable solutions, suspension concentrates (SC), oil- or water-based dispersions, oil-miscible solutions, capsule suspensions (CS), dusts (DP), seed-dressing materials, granules (GR) in the form of microgranules, spray granules, coated granules and adsorption granules, water-dispersible granules (WG), water-soluble granules (SG), ULV formulations, microcapsules and waxes.

These individual formulation types are known in principle and are described, for example, in: Winnacker-Kuchler, “Chemische Technologie” [Chemical Engineering], Volume 7, C. Hauser Verlag Munich, 4.sup.th Ed. 1986; Wade van Valkenburg, “Pesticide Formulations”, Marcel Dekker, N.Y., 1973; and K. Martens, “Spray Drying” Handbook, 3rd Ed. 1979, G. Goodwin Ltd. London.

The formulation auxiliaries required, such as inert materials, surfactants, solvents and additives, are also known and are described, for example, in Watkins, “Handbook of Insecticide Dust Diluents and Carriers”, 2nd Ed., Darland Books, Caldwell N.J.; H. v. Olphen, “Introduction to Clay Colloid Chemistry”, 2nd Ed., J. Wiley & Sons, N.Y.; C. Marsden, “Solvents Guide”; 2nd Ed., Interscience, N.Y. 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., N.Y. 1964; Schonfeldt, “Grenzflchenaktive thylenoxidaddukte” [Surface-active ethylene oxide adducts], Wiss. Verlagsgesell., Stuttgart 1976; and Winnacker-Kuchler, “Chemische Technologie”, Volume 7, C. Hauser Verlag Munich, 4.sup.th Ed. 1986.

Based on these formulations, it is also possible to prepare combinations with other agrochemical active substances such as insecticides, acaricides, fertilizers and/or growth regulators, for example in the form of a ready-mix or a tank mix.

Wettable powders are products which are uniformly dispersible in water and which, besides the fungicide also comprise diluents or inert materials and, if appropriate further ionic and/or nonionic surfactants (wetters, dispersants), for example polyoxyethylated alkylphenols, polyoxethylated fatty alcohols, polyoxethylated fatty amines, fatty alcohol polyglycol ether sulfates, alkanesulfonates, alkylbenzenesulfonates, sodium lignosulfonates, sodium 2,2′-dinaphthylmethane-6,6′-disulfonate, sodium dibutyinaphthalene sulfonate or else sodium oleoylmethyltaurine. To prepare the wettable powders, the fungicides and/or surfactants are finely ground, for example in customary apparatuses such as hammer mills, blower mills and air-jet mills, and mixed with the formulation auxiliaries, either simultaneously or subsequently. Emulsifiable concentrates are prepared by dissolving fungicide and/or surfactants in an organic solvent, for example butanol, cyclohexanone, dimethylformamide, xylene, glycols, methyl esters of natural fatty acids or else higher-boiling aromatics or hydrocarbons or mixtures of the organic solvents with addition of one or more ionic or nonionic surfactants (emulsifiers). Examples of emulsifiers which may be used are: calcium salts of alkylarylsulfonic acid, such as calcium dodecylbenzenesulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan esters such as, for example, sorbitan fatty acid esters, or polyoxyethylene sorbitan esters such as, for example, polyoxyethylene sorbitan fatty acid esters.

Dusts are obtained by grinding fungicide and/or surfactant with finely divided solid materials, for example talc, natural clays such as kaolin, bentonite and pyrophyllite, or diatomaceous earth.

Emulsions, for example oil-in-water emulsions (EW), can be prepared for example by means of stirrers, colloid mills and/or static mixers using aqueous organic solvents and, if appropriate, further surfactants as have already been mentioned for example above in the case of the other formulation types. The stability of esters in water may be a concern, in which case the pH of the solution needs to be maintained between 6 and 7.5 to minimize hydrolytic degradation. Additionally, reductive agents can be added to the solution, or additional alcohols or polyols can be added to the solution.

Granules can be prepared either by spraying the fungicide and/or surfactants onto adsorptive, granulated inert material or by applying active ingredient concentrates to the surface of carriers such as sand, kaolinites or granulated inert material with the aid of adhesives, for example polyvinyl alcohol, sodium polyacrylate or else mineral oils. Suitable fungicide may also be granulated in the manner conventionally used for the production of fertilizer granules, if desired in a mixture with fertilizers. As a rule, water-dispersible granules are prepared by conventional processes such as spray drying, fluidized-bed granulation, disk granulation, mixing with high-speed mixers and extrusion without solid inert material. Regarding the production of disk granules, fluidized-bed granules, extruder granules and spray granules, see, for example, the methods in “Spray-Drying Handbook” 3rd Ed. 1979, G. Goodwin Ltd., London; J. E. Browning, “Agglomeration”, Chemical and Engineering 1967, page 147 et seq; and “Perry's Chemical Engineer's Handbook”, 5th Ed., McGraw-Hill, New York 1973, pp. 8-57.

For further details on the formulation of crop protection products, see, for example, G. C. Klingman, “Weed Control as a Science”, John Wiley and Sons, Inc., New York, 1961, pages 81-96; and J. D. Freyer, S. A. Evans, “Weed Control Handbook”, 5th Ed., Blackwell Scientific Publications, Oxford, 1968, pages 101-103.

In addition, the abovementioned active ingredient formulations may comprise, if appropriate, additives such as adhesives, wetters, dispersants, emulsifiers, penetrants, preservatives, antifreeze agents, solvents, fillers, carriers, colorants, antifoams, evaporation inhibitors, pH regulators or viscosity regulators which are customary in each case.

The spray mixture is preferably prepared on the basis of water and/or an oil, for example a high-boiling hydrocarbon such as kerosene or paraffin. The fungicidal compositions according to the invention can be formulated as a tank mix or a ready-mix.

The active ingredient concentration in wettable powders is, for example, approximately 10 to 90% by weight, the remainder to 100% by weight being composed of customary formulation constituents. In the case of emulsifiable concentrates, the active ingredient concentration may amount to approximately 1 to 90%, preferably 5 to 80% by weight. Formulations in the form of dusts comprise 1 to 30% by weight of active ingredient, preferably in most cases 5 to 20% by weight of active ingredient; and sprayable solutions contain approximately 0.05 to 80%, preferably 2 to 50% by weight of active ingredient. In the case of water-dispersible granules, the active ingredient content depends partly on whether the active compound is present in liquid or solid form and on which granulation auxiliaries, fillers and the like are being used. The active ingredient content amounts to, for example, between 1 and 95% by weight, preferably to between 10 and 80% by weight in the case of the water-dispersible granules.

Upon application, the concentration of fungicide is generally 0.0001 to 20% by weight, preferably 0.01 to 3% by weight, in the composition applied, for example the spray mixture, at an application rate of 5 to 4000 l/ha, preferably 100 to 600 l/ha.

Preferably, the fungicidal compositions according to the invention additionally comprise water and if appropriate, organic solvents and are formulated in the form of an aqueous concentrated dispersion or emulsion or as a tank mix in the form of a dilute dispersion, emulsion or solution with a degree of dilution of up to that of the ready-to-use spray mixture. A fungicidal composition prepared as a tank mix and comprising, for use, the preferred amounts of fungicide is especially preferred.

Mixtures or co-formulations with other active substances such as, for example, insecticides, acaricides, fungicides, fungicides, fertilizers and/or growth regulators are possible, if appropriate.

For use, concentrated formulations which are present in commercially available form are, if appropriate, diluted in the customary fashion, for example by means of water in the case of wettable powders, emulsifiable concentrates, dispersions and water-dispersible granules. Preparations in the form of dusts, spray granules, absorption granules, sprayable solutions and spray mixtures prepared as tank mixes are not conventionally diluted further with additional inert substances prior to use.

The application rate required of the fungicides varies with the external conditions such as temperature, humidity and the nature of the fungicide used. It can vary within wide limits, for example between 0.001 and 10 kg/ha or more of active substance, but it is preferably between 0.005 and 5 kg/ha.

The invention will now be described with reference to a number of specific examples that are to be regarded solely as illustrative of the compositions of this invention and not as restrictive of the scope thereof.

### EXAMPLE 1

(RS)-2,4-dichloro-α-(pyrimidin-5-yl)benzhydryl (E)-2-{2-[6-(2-cyanophenoxy)pyrimidin-4-yloxy]phenyl}-3-methoxyacrylate. This fungicidal product is effective against the following fungal pathogens: Late blight (Phytophthora infestans), Powdery mildew (Erisyphe araminis), Brown rust (Puccinia recondita), and Septoria leaf spot (Septoria tritici) on tomatoes, wheat and vine crops.

### EXAMPLE 2

(2RS,3RS;2RS,3SR)-2-(4-chlorophenyl)-3-cyclopropyl-1-(1H-1,2,4-triazol-1-yl)butan-2-yl (E)-methoxyimino[α-(o-tolyloxy)-o-tolyl]acetate. This fungicidal product is effective against the following fungal pathogens: Late blight (Phytophthora infestans), Powdery mildew (Erisyphe araminis), Brown rust (Puccinia recondita), and Septoria leaf spot (Septoria tritici) on tomatoes, wheat and vine crops.

### EXAMPLE 3

(RS)-1-p-chlorophenyl-4,4-dimethyl-3-(1H-1,2,4-triazol-1-ylmethyl)pentan-3-yl (E)-methoxyimino-{(E)-α-[1-(α,α,α-trifluoro-m-tolyl)ethylideneaminooxy]-o-tolyl}acetate. This fungicidal product is effective against the following fungal pathogens: Late blight (Phytophthora infestans), Powdery mildew (Erisyphe araminis), Brown rust (Puccinia recondita), and Septoria leaf spot (Septoria tritici) on tomatoes, wheat and vine crops.

1. A compound of the formula: (RCOO)ₙ—R′ wherein
RCOO is each independently an acetate of an acid selected from the group consisting of:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim),
(RS)-3-(3,5-dichlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyraclostrobin), and
(E)-methoxyimino-{(E)-α-[1-(α,α,α-trifluoro-m-tolyl)ethylideneaminooxy]-o-tolyl}acetic acid (trifloxystrobin);
R′ is an alkyl group of a polyol containing two or more carbon atoms, which may be linear or branched, saturated or unsaturated, substituted or unsubstituted; and
n is 1 or greater, the maximum number being determined according to the degree of esterification that the polyol will allow.

2. A compound of the formula: (RCOO)ₙ—R′ wherein
RCOO is each independently an acetate of an acid selected from the group consisting of:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim),
(RS)-3-(3,5-dichlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyraclostrobin), and
(E)-methoxyimino-{(E)-α-[1-(α,α,α-trifluoro-m-tolyl)ethylideneaminooxy]-o-tolyl}acetic acid (trifloxystrobin);
R′ is an alkyl group of a polyol selected from the group consisting of:
glycols (for example: ethylene glycol, propylene glycol, butylenes glycol, hexylene glycol, dipropyleneglycol, triethyleneglycol, methoxytriglycol, ethoxytriglycol, tripropylene glycol methyl ether),
sorbitol,
sorbitan/sorbitol poly(oxyalkylene) condensates (in molecular weight range of 40 a.u. to 20000 a.u.),
D-mannitol,
D-mannitol poly(oxyalkylene) condensates (in molecular weight range of 40 a.u. to 20000 a.u.),
poly(oxyalkylene) glycols in molecular weight range of 80 au. to 20000 a.u.,
mono-capped poly(oxyalkylene) glycols in molecular weight range of 80 a.u. to 20000 a.u. capped with an alkyl or aryl group,
pentaerythritol,
pentaerythritol poly(oxyalkylene) condensates,
polyvinylalcohols,
glucosides,
polyglucosides,
polyvinylalcohol polymers,
glycerol,
glycerol poly(oxyalkylene) condensates,
polysaccharides; polysaccharide poly(oxyalkylene) condensates,
polyglycerides,
polyglyceride poly(oxyalkylene) condensates,
poly(oxyalkylene)amines, and
poly(oxyalkylene)etheramines; and
n is 1 or greater, the maximum number being determined according to the degree of esterification that the polyol will allow.

3. A compound of the formula RCOO—R′ wherein
RCOO is an acetate of an acid selected from the group consisting of:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim),
(RS)-3-(3,5-dichlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyracolstrobin), and
(E)-methoxyimino-{(E)-α-[1-(α,α,α-trifluoro-m-tolyl)ethylideneaminooxy]-o-tolyl}acetic acid (trifloxystrobin); and
R′ represents an alkyl group of a fungicidally active alcohol.

4. A compound of the formula RCOO—R′ wherein
RCOO is an acetate of an acid selected from the group consisting of:
(E)-3-methoxy-2-{2-[6-(trifluoromethyl)-2-pyridyloxymethyl]phenyl}acrylic acid (picoxystrobin),
(E)-methoxyimino[α-(o-tolyloxy)-o-tolyl]acetic acid (kresoxim),
(RS-3-(3,5-chlorophenyl)-5-methyl-2,4-dioxo-1,3-oxazolidine carboxylic acid (chlozolinate),
2-furoyl-N-2,6-xylyl-DL-alanine (furalaxyl),
N-methoxyacetyl-N-2,6-xylyl-DL-alanine (metalaxyl),
N-phenylacetyl-N-2,6-xylyl-DL-alaninine (benalaxyl),
5-(2-amino-5-O-carbamoyl-2-deoxy-L-xylonamido)-1-(5-carboxy-1,2,3,4-tetrahydro-2,4-dioxopyrimidin-1-yl)-1,5-dideoxy-β-D-allofuranuronic acid (polyoxorim),
5-nitroisophthalic acid (nitrothal),
(E)-2-{2-[6-(2-cyanophenoxy)pyrimidin-4-yloxy]phenyl}-3-methoxyacrylic acid (azoxystrobin),
(αE)-(methoxymethylene)-2-[[[6-(trifluoromethyl)-2-pyridinyl]oxy]methyl]benzeneacetic acid (picoxystrobin),
N-{2-[1-(4-chlorophenyl)-1H-pyrazol-3-yloxymethyl]phenyl}(N-methoxy)carbamic acid (Pyracolstrobin), and
(E)-methoxyimino-{(E)-α-[1-(α,α,α-trifluoro-m-tolyl)ethylideneaminnooxy]-o-tolyl}acetic acid (trifloxystrobin); and
R′ represents an alkyl group of an alcohol selected from the group consisting of:
(2RS,3RS;2RS,3SR)-2-(4-chlorophenyl)-3-cyclopropyl-1-(1H-1,2,4-triazol-1-yl)butan-2-ol (cyproconazole),
(1RS,2SR,5RS;1RS,2SR,5SR)-2-(4-chlorobenzyl)-5-isopropyl-1-(1H-1,2,4-triazol-1-ylmethyl)cyclopentanol (ipconazole),
(1RS,5RS;1RS,5SR)-5-(4-chlorobenzyl)-2,2-dimethyl-1-(1H-1,2,4-triazol-1-ylmethyl)cyclopentanol (metconazole),
(RS)-2-(4-fluorophenyl)-1-(1H-1,2,4-triazol-1-yl)-3-(trimethylsilyl)propan-2-ol (simeconazole),
(RS)-1-p-chlorophenyl-4,4-dimethyl-3-(1H-1,2,4-triazol-1-ylmethyl)pentan-3-ol (tebuconazole),
(RS)-(E)-5-(4-chlorobenzylidene)-2,2-dimethyl-1-(1H-1,2,4-triazol-1-ylmethyl)cyclopentanol (triticonazole),
5-butyl-2-ethylamino-6-methylpyrimidin-4-ol (ethirimol),
5-butyl-2-dimethylamino-6-methylpyrimidin-4-ol (dimethirimol),
(RS)-2,4′-dichloro-α-(pyrimidin-5-yl)benzhydryl alcohol (fenarimol),
(RS)-2-chloro-4′-fluoro-α-(pyrimidin-5-yl)benzhydryl alcohol (nuarimol),
(RS)-2,4-dichloro-α-(pyrimidin-5-yl)benzhydryl alcohol (triarimol),
β-([1,1′-biphenyl]-4-yloxy)-α-(1,1-dimethylethyl)-1H-1,2,4-triazole-1-ethanol (bitertanol),
(RS)-2-(2,4-dichlorophenyl)-1-(1H-1,2,4-triazol-1-yl)hexan-2-ol,
(RS)-2,4-difluoro-α-(1H-1,2,4-triazol-1-ylmethyl)benzhydryl alcohol,
(E)-(RS)-1-(2,4-dichlorophenyl)-4,4-dimethyl-2-(1H-1,2,4-triazol-1-yl)pent-1-en-3-ol,
(2RS,3RS)-1-(2,4-dichlorophenyl)-4,4-dimethyl-2-(1H-1,2,4-triazol-1-yl)pentan-3-ol,
(RS)-2-[2-(1-chlorocyclopropyl)-3-(2-chlorophenyl)-2-hydroxypropyl]-2,4-dihydro-1,2,4-triazol-3-thione, and
(1RS,2RS;1RS,2SR)-1-(4-chlorophenoxy)-3,3-dimethyl-1-(1H-1,2,4-triazol-1-yl)butan-2-ol.

5. A compound of the formula
R₁—O—CO—(CH₂)ₓ—[CH(NH₂]_{y}—[CH(OH)]_{z}—[C(OH)(COOR₁)—CH₂]_{w}—COOR₁
wherein 0≦x≧12 and 0≦y≧1 and 0≦z≧4 and 0≦w≧1;
R₁ each independently represents an alkyl group of an alcohol selected from the group consisting of:
(2RS,3RS;2RS,3SR)-2-(4-chlorophenyl)-3-cyclopropyl-1-(1H-1,2,4-triazol-1-yl)butan-2-ol (cyproconazole),
(1RS,2SR,5RS;1RS,2SR,5SR)-2-(4-chlorobenzyl)-5-isopropyl-1-(1H-1,2,4-triazol-1-ylmethyl)cyclopentanol (ipconazole),
(1RS,5RS;1RS,5SR)-5-(4-chlorobenzyl)-2,2-dimethyl-1-(1H-1,2,4-triazol-1-ylmethyl)cyclopentanol (metconazole),
(RS)-2-(4-fluorophenyl)-1-(1H-1,2,4-triazol-1-yl)-3-(trimethylsilyl)propan-2-ol (simeconazole),
(RS)-1-p-chlorophenyl-4,4-dimethyl-3-(1H-1,2,4-triazol-1-ylmethyl)pentan-3-ol (tebuconazole),
(RS)-(E)-5-(4-chlorobenzylidene)-2,2-dimethyl-1-(1H-1,2,4-triazol-1-ylmethyl)cyclopentanol (triticonazole),
5-butyl-2-ethylamino-6-methylpyrimidin-4-ol (ethirimol),
5-butyl-2-dimethylamino-6-methylpyrimidin-4-ol (dimethirimol),
(RS)-2,4′-dichloro-α-(pyrimidin-5-yl)benzhydryl alcohol (fenarimol),
(RS)-2-chloro-4′-fluoro-α-(pyrimidin-5-yl)benzhydryl alcohol (nuarimol),
(RS)-2,4-dichloro-α-(pyrimidin-5-yl)benzhydryl alcohol (triarimol),
β-([1,1′-biphenyl]-4-yloxy)-α-(1,1-dimethylethyl)-1H-1,2,4-triazole-1-ethanol (bitertanol),
(RS)-2-(2,4-dichlorophenyl)-1-(1H-1,2,4-triazol-1-yl)hexan-2-ol,
(RS)-2,4-difluoro-α-(1H-1,2,4-triazol-1-ylmethyl)benzhydryl alcohol,
(E)-(RS)-1-(2,4-dichlorophenyl)-4,4-dimethyl-2-(1H-1,2,4-triazol-1-yl)pent-1-en-3-ol,
(2RS,3RS)-1-(2,4-dichlorophenyl)-4,4-dimethyl-2-(1H-1,2,4-triazol-1-yl)pentan-3-ol,
(RS)-2-[2-(1-chlorocyclopropyl)-3-(2-chlorophenyl)-2-hydroxypropyl]-2,4-dihydro-1,2,4-triazol-3-thione, and
(1RS,2RS;1RS,2SR)-1-(4-chlorophenoxy)-3,3-dimethyl-1-(1H-1,2,4-triazol-1-yl)butan-2-ol.

6. A composition suitable for the controlling the development of unwanted fungus species on crops which comprises a fungicidally effective amount of a compound of claim 1 and a compound selected from the group consisting of surfactant, solid diluent, liquid diluent and mixtures thereof.

7. A composition suitable for the controlling the development of unwanted fungus species on crops which comprises a fungicidally effective amount of a compound of claim 3 and a compound selected from the group consisting of surfactant, solid diluent, liquid diluent and mixtures thereof.

8. A composition suitable for the controlling the development of unwanted fungus species on crops which comprises a fungicidally effective amount of a compound of claim 5 and a compound selected from the group consisting of surfactant, solid diluent, liquid diluent and mixtures thereof.

9. A method for controlling the development of unwanted fungus species on crops which comprises applying to the locus to be protected a fungicidally effective amount of a compound of claim 1.

10. A method for controlling the development of unwanted fungus species on crops which comprises applying to the locus to be protected a fungicidally effective amount of a compound of claim 3.

11. A method for controlling the development of unwanted fungus species on crops which comprises applying to the locus to be protected a fungicidally effective amount of a compound of claim 5.
